(19) United States
(12) Patent Application Publication
(10) Pub. No.: US 2002/0124230 A1
(43) Pub. Date: Sep. 5, 2002

(54) Timing optimization for integrated circuit design

(76) Inventors: Zhen Cai, Singapore (SG); Lixin Liang, Singapore (SG)

Correspondence Address: James D. Ivey, Law Offices Of James D. Ivey, 3025 Totterdell Street, Oakland, CA, 94611-1742, US

(21) Appl. No.: 09/755,626

(22) Filed: Jan. 4, 2001

(51) Int. Cl. G06F 17/50

(52) U.S. Cl. 716/6; 716/4; 716/5

(57) ABSTRACT

Timing of a global network of a circuit design is processed globally while modifications to the global network are associated with logical blocks of the circuit design. Accordingly, the global network can be divided at boundaries of the logical blocks after timing is optimized globally. Paths with the worst timing problems are processed first, and devices of the path which the largest delays are processed first. Improvements in a path's timing are achieved by replacing overloaded devices with bigger ones and/or by inserting buffers. Path segments though un-routed soft blocks are estimated by determining a density center of driven devices, determining a distance to the density center, and adding distances from the density center to each of the driven devices. Devices are categorized according to delays corresponding to driven capacitances. For each device delays are calculated and mapped for various driven capacitances and adjusted for the physical size of each device.

### BACKGROUND OF THE INVENTION

Many electrical circuits designed today are extremely complex and include, for example, many millions of individual circuit elements such as transistors and digital logic gates. Circuit complexity has greatly surpassed the capacity of all conventional design techniques using computer aided design systems. In particular, circuit complexity is challenging the available resources of even the largest, most sophisticated computer aided automatic layout place and route design systems.

There are primarily three paradigms by which automatic layout place and route design systems are used by engineers to design electrical circuits layout. The first is called the flat paradigm. In the flat paradigm, the circuit under design is represented entirely at a physical layout abstraction level such that individual logic gates and pre-laid-out function blocks are shown directly and are placed and routed directly by automatic layout techniques. The advantage of the flat paradigm is that optimization of the global placement of layout gates and global wiring of connections between gates is relatively easy. The disadvantage of the flat paradigm is that the requisite computer resources and computing time necessary for processing the circuit design, e.g., to optimize timing, increase exponentially with an increase of complexity of the circuit under design and can quickly overwhelm the computer capacity of any computer aided design system and the project design schedule.

This disadvantage of the flat paradigm is overcome by the second paradigm, i.e., the hierarchical paradigm. In the hierarchical paradigm, circuit elements are combined into functional blocks such that the functional blocks serve as abstractions of underlying circuit elements. Such functional blocks can be combined into larger, more abstract, functional blocks of a higher level of a hierarchy. For example, a computer processor can be designed as including a relatively small number of functional blocks including a memory management block, an input/output block, and an arithmetic logic unit. The arithmetic logic unit can be designed to include a relatively small number of functional blocks including a register bank, an integer processing unit, and a floating point processing unit. The integer processing unit can include sub-blocks such as an adder block, a multiplier block, and a shifter block. At the lower levels of the hierarchical design specification, blocks are as simple as flip-flops and digital logic gates, and blocks are individual elements such as transistors, resistors, capacitors, inductors, and diodes at the lowest level of the hierarchy.

The primary advantage of the hierarchical paradigm is that engineers can design complex circuits by designing relatively small functional blocks and using such designed blocks to build bigger blocks. In other words, the seemingly insurmountable job of designing a highly complex circuit is divided into small, workable design projects. Each of the function blocks can be easily placed and routed by the flat paradigm. The use of computer resources and computing time can be controlled simply by this paradigm. In addition, functional blocks designed for one circuit can be used as components of a different circuit, thereby reducing redundant effort by the engineers.

The primary disadvantage of the hierarchical paradigm is that significantly accurate global net wiring is particularly difficult to realize since each functional block of a hierarchical design is independently instantiated to render a flat layout of the specific electrical elements which implement the hierarchical design. The timing delay skew of a clock net, for example, between such independently instantiated functional blocks must be minimized in a layout design, i.e., various flip-flop logic gates must receive a global clock signal in the same time. However, in the actual design, electrical signals propagate from a source to various destinations at different times due to variations in specific routes and surrounding conditions. Several conventional techniques for resolving timing delay skews, e.g., the “Clock-Tree-Synthesis,” require circuit designs specifying according to the flat paradigm to minimize the timing delay skew. Circuit design according to the hierarchical paradigm is generally inadequate to resolve global net routing requirements since the functional blocks have been abstracted and fixed.

The third paradigm is called the “Hybrid Paradigm” and provides the advantages of both the flat and hierarchical paradigms by which a hierarchical design can be more efficiently and accurately rendered to a layout-level circuit. This hybrid paradigm is described more completely in U.S. patent application Ser. No. 09/098,599 by Cai, Zhen and Zhang, Qiao Ling entitled “Hybrid Design Method and Apparatus for Computer-Aided Circuit Design” filed Jun. 17, 1998(hereinafter the '599 Application). Circuit layout design using CAD systems according to the hybrid paradigm have shown significantly better performance than systems according to either of the other two paradigms.

Timing optimization is generally straight-forward for designs specified according to the flat paradigm. However, any changes to the design after timing optimization of a network of the design require substantial processing resources. As described above, such requisite processing resources grow exponentially with design complexity and the flat paradigm is therefore not practical for optimizing timing of particularly large circuit designs, such as System On a Chip (SOC) designs.

Timing optimization for designs specified according to the hierarchical paradigm is inadequate for a number of reasons. In the hierarchical paradigm, logic blocks of the design are processed independently of the remainder of the design. However, timing constraints are typically specified along paths from one input/output (I/O) pad of the design to another—i.e., typically across several logical blocks. To accomplish timing optimization in hierarchically specified designs, a constraint for a path through multiple logical blocks is typically partitioned into constraint segments at logic block boundaries. Then, each logical block is processed independently of the remainder of the design to ensure that the portion of the path within a logical block satisfies its own constraint segment.

The constraint segments are typically estimated according to the size of the respective logical blocks. Such estimation is somewhat arbitrary and can result in unrealistic constraints being applied in some instances. The following example is illustrative. Consider that a path passes through a particularly large logical block which includes relatively few devices on that path and through a particularly small logical block which includes numerous devices on that path. Estimation of constraint segments according to logical block size imposes an unnecessarily stringent timing constraint upon the smaller logical block without regard for the fact that too much of the overall timing constraint is unnecessarily allocated to the larger logical block. The problem, simply stated, is that timing optimization is a global problem and looking at less than the entire design is inadequate to address the problem. As used herein in the context of circuit designs, “global” refers to a design as a whole.

Hybrid paradigm circuit designs are very new and the problem of timing optimization as a global problem in a partitioned, hybrid paradigm circuit design has heretofore not been addressed in detail.

What is needed is a system for optimizing timing of a global network distributed through soft blocks of a hybrid circuit design that adequately utilizes the advantages of the hybrid paradigm of circuit design.

### SUMMARY OF THE INVENTION

In accordance with the present invention, timing of a global network through a circuit design is optimized globally, i.e., as a whole, while any changes made to the global network are associated with logical blocks within the circuit design to facilitate subsequent processing of the circuit design according to a hybrid paradigm. In essence, the accuracy and efficient result of optimizing timing of a network globally rather than in segments is provided and yet the ability to later process soft blocks of the circuit design individually to provide the advantage of significantly improved processing efficiency.

To track the logical blocks within which various parts of the global network belong during timing optimization, the global network is divided into paths and each path is divided into path segments at soft block boundaries. Each path segment is associated with a logical block, e.g., either a soft block or the top level. For example, a path which crosses two soft blocks can include (i) a path segment at the top level from an input/output pad to the boundary of the first soft block, (ii) a path segment within the first soft block, (iii) a path segment at the top level from the first soft block to the second soft block, (iv) a path segment within the second soft block, and (v) a path segment at the top level from the second soft block to an input/output pad. Each time a change is made to a path to improve timing of the path, the change is made within a path segment and the change is associated with the logical block of that path segment. Accordingly, when the circuit is subsequently divided into individual soft blocks for more efficient processing, any changes during the timing optimization are included in the appropriate individual soft blocks.

To optimize timing in the circuit design, the individual paths of the global network are determined. Each path is compared to its associated design constraint to determine the slack time of each path. Paths with negative slack times are in violation of their respective constraints, and the path with the least slack time, i.e., the negative slack time with the greatest magnitude, is the path which has the worst timing situation. The paths are processed in order of ascending order such that paths with the worst timing situations are processed first.

The advantage of processing the paths with the worst timing situations first is that changes to the worst path may simultaneously solve timing issues for paths which are partly coincident. For example, if a device for one path is replaced with a faster device, other paths which included the replaced device also have their timing improved. Solving timing issues for the worst paths first increases the chances that other paths are improved, thereby reducing timing optimization that must later be performed on those other paths.

Each path is optimized individually by dividing the path into nodes. Each node begins at the input of the device and ends at the inputs of devices driven by the device. Thus, each node typically includes a device and output lines driven by the device. The delay for each node of the path is determined and the nodes are processed in order of descending delay. Thus, the nodes with the longest delay are processed first.

The advantage of processing the nodes with longest delay first is that the nodes with longest delays are typically those which are most likely to benefit from changes. Starting with the node with the longest delay, it is determined whether the node is overloaded and whether a bigger equivalent device is available. In general, each device is categorized according to the capacitance that can be driven by the device. If the device is currently driving more capacitance than it should, it is determined whether a bigger, equivalent device is available. A device is equivalent if it performs the same function. For example, logical AND gates are generally equivalent to one another. A device is bigger if it can generally drive a greater capacitance with less delay. Thus, bigger can also be thought of as faster herein. In general, there is a correlation between device area and device speed.

If the device of the currently processed node is overloaded and has a bigger equivalent, the device is tentatively replaced with the bigger equivalent. The delay through the path with the substituted device is determined and compared to the prior delay. If the delay is improved, the change is kept and processing of the path starts over unless the path now satisfies its constraint. The substituted device is included in the appropriate path segment such that subsequently dividing the circuit design into soft block for individual processing includes the substituted device in the appropriate logical block.

If there is no bigger equivalent for the device of the currently processed node, the node with the next longest delay is processed. It's possible that a path still violates its constraint and no bigger equivalents are available for any of its devices. In this situation, the nodes are again processed in order of descending delay and each node is tested to see if inserting a buffer at the output of the device of the node improves timing of the path. If so, the path is re-evaluated and re-processed if the path continues to violated its constraint. If not, the buffer is not inserted and the node with the next longest delay is tested. Any added buffer is inserted in the path segment of the node such that the buffer is included in the appropriate logical block if the circuit design is subsequently divided into soft blocks for individual processing.

By addressing paths with the least slack times first and the nodes of those paths with the greatest delays first, timing problems are quickly and efficiently corrected. In addition, tracking associated logical blocks of changes made to each path ensures that the processing efficiencies of dividing circuit designs into soft blocks are preserved after global timing processing.

Sometimes it is desirable to solve timing problems when less than the entirety of the global network is routed. To do so requires an estimation of line lengths to driven devices. Further in accordance with the present invention, such line lengths are estimated using a density center of the driven devices. In particular, the density center of the driven devices is determined and a hypothetical trunk line connects the density center with a soft pin entering the un-routed soft block. The distances from the density center to each driven device is determined and added to the trunk line to estimate routing within the soft block. Since the line delay is small relative to the delay of a signal through a device, the estimated routing provides a reliable estimate for evaluating and improving timing in the manner described herein.

To process a global network in the manner described herein, it is helpful to categorize devices according to delays associated with driven capacitances. For example, a database of which equivalent devices are capable of driving which capacitances is particularly useful.

To categorize equivalent devices, each device is evaluated according to a non-linear delay model for the device. In particular, a constant slew is selected and the non-linear delay model for each device is used to produce a mapping of driven capacitances to delays. Additional driven capacitances and associated delays are interpolated to produce a finer resolution of the relation between driven capacitances and delays for the device.

When comparing devices, smaller devices typically provide the least delay for small driven capacitances, medium-sized devices typically provide the least delay for moderate driven capacitances, and large devices typically provide the least delay for large driven capacitances. However, it is possible that a large device can provide the least delay for all driven capacitances. Therefore, it is preferred to factor in size to thereby favor smaller sized devices when appropriate. Accordingly, the mapping of driven capacitance to delay for each device is scaled according to the physical size of the device.

Once each device is mapped and scaled according to size, comparison reveals which devices provide the least delay for which driven capacitances. This information can be used to determine (i) whether a particular device is overloaded and (ii) which equivalent device can be substituted to provide a better size-delay compromise.

### BRIEF DESCRIPTION OF THE DRAWINGS

FIG. 1 is a block diagram of a circuit design which includes a number of logical blocks and a global network.

FIG. 2 is a block diagram of a data structure representing a path of a global network and path segments of the path in accordance with the present invention.

FIG. 3 is a logic flow diagram of the processing of the timing of a global network in accordance with the present invention.

FIG. 4 is a logic flow diagram of the processing of a path to improve timing of the path in accordance with the present invention.

FIG. 5 is a logic flow diagram of the testing of a tentative modification of a path to improve timing.

FIG. 6 is a logic flow diagram of the process by which outgoing load is estimated in accordance with the present invention.

FIG. 7 is a block diagram illustrating the use of density center of driven elements to estimate outgoing load in accordance with the present invention.

FIG. 8 is a logic flow diagram of device classification according to delay and driven capacitance in accordance with the present invention.

FIG. 9 is a mapping of delay to driven capacitance for a device.

FIG. 10 is a mapping of delay to driven capacitance for two devices, illustrating adjustment for relative physical sizes of the devices.

FIG. 11 is a mapping of delay to driven capacitance for three devices, illustrating the categorization according to least delays.

FIG. 12 is a block diagram of a computer system which includes a computer aided design (CAD) application and design specific database in accordance with the present invention.

### DETAILED DESCRIPTION OF THE INVENTION

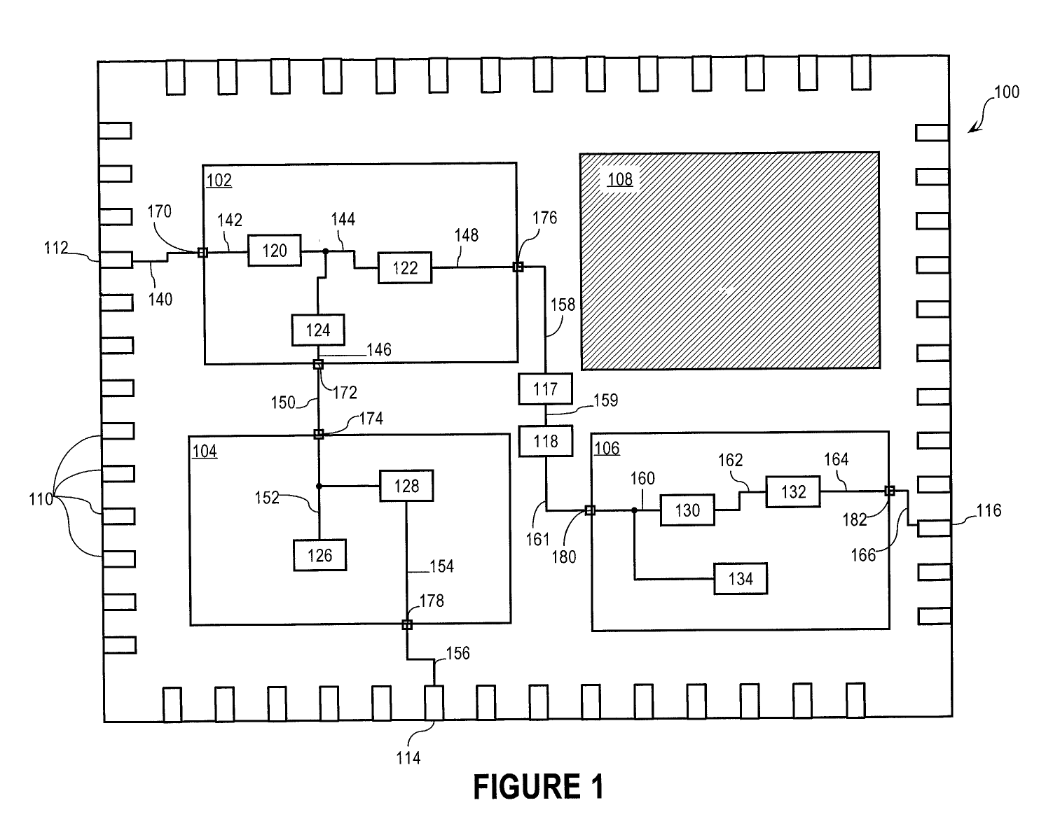

In accordance with the present invention, timing of a global network through a circuit design 100 (FIG. 1) is optimized globally, i.e., as a whole, while any changes made to the global network are associated with logical blocks within the circuit design to facilitate subsequent processing of circuit design 100 according to a hybrid paradigm. The logical blocks include the top level of circuit design 100 and soft blocks 102, 104, and 106.

Circuit design 100 (FIG. 1) is a hybrid design and includes soft blocks 102, 104, and 106 and hard block 108. Hard block 108 is fixed within circuit design 100 and cannot be moved or changed. Soft blocks 102, 104, and 106 each include elements which can be moved, e.g., to reduce overall size of circuit design 100 or to improve timing of signal propagated through circuit design 100. Circuit design 100 also includes a number of input/output pads 110 to which wires can be attached for sending data signals to, and receiving data signals from, the circuit represented by circuit design 100.

In this illustrative embodiment, a global network which is routed through soft blocks 102, 104, and 106 begins at line 140 and ends at lines 156 and 166. The global network includes two paths: one from I/O pad 112 to I/O pad 114 and another from I/O pad 112 to I/O pad 116. The first path passes through elements 120 and 124 of soft block 102, through element 128 of soft block 104, to I/O pad 114. The second path pass through elements 120 and 122 of soft block 102, through elements 117 and 118 of the top level, and through elements 130 and 132 of soft block 106 to I/O pad 116. The global network is divided at soft block boundaries by soft pins 170-182 in the manner described in the '599 Application and that description is incorporated herein by reference. In the context of design 100, the top level includes all elements not included in any soft or hard blocks of design 100.

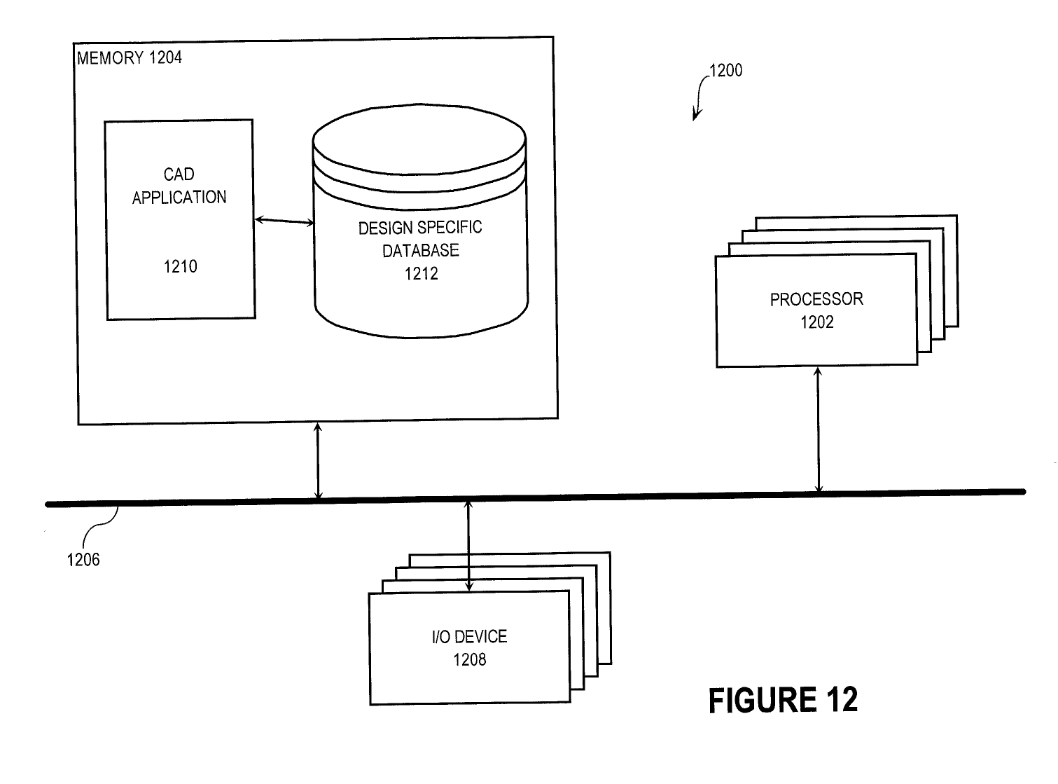

Creation and processing of circuit design 100 is performed by a computer-aided design (CAD) application 1210 (FIG. 12) which is all or part of one or more computer processes executing within computer system 1200. Computer system 1200 includes one or more processors 1202 and a memory 1204 which can include randomly accessible memory (RAM) and read-only memory (ROM) and can include generally any storage medium such as magnetic and/or optical disks. Memory 1204 and processors 1202 interact with one another through an interconnect 1206.

A user interacts with CAD application 1210 through one or more input/output (I/O) devices 1208 which can include, for example, a keyboard, an electronic mouse, trackball, tablet or similar locator device, an optical scanner, a printer, a CRT or LCD monitor, and/or a network access device through which computer system 1200 can be connected to a computer network. Under control of such a user, e.g., through physical manipulation of one or more of I/O devices 1208, CAD application 1210 manipulates a design specification database 1212 which is stored in memory 1204. While computer system 1200 is shown to be a single computer system, it is appreciated that CAD application 1210 and/or design specification database 1212 can be distributed over multiple computer systems, e.g., in the manner described in the '599 Application and that description is incorporated herein by reference.

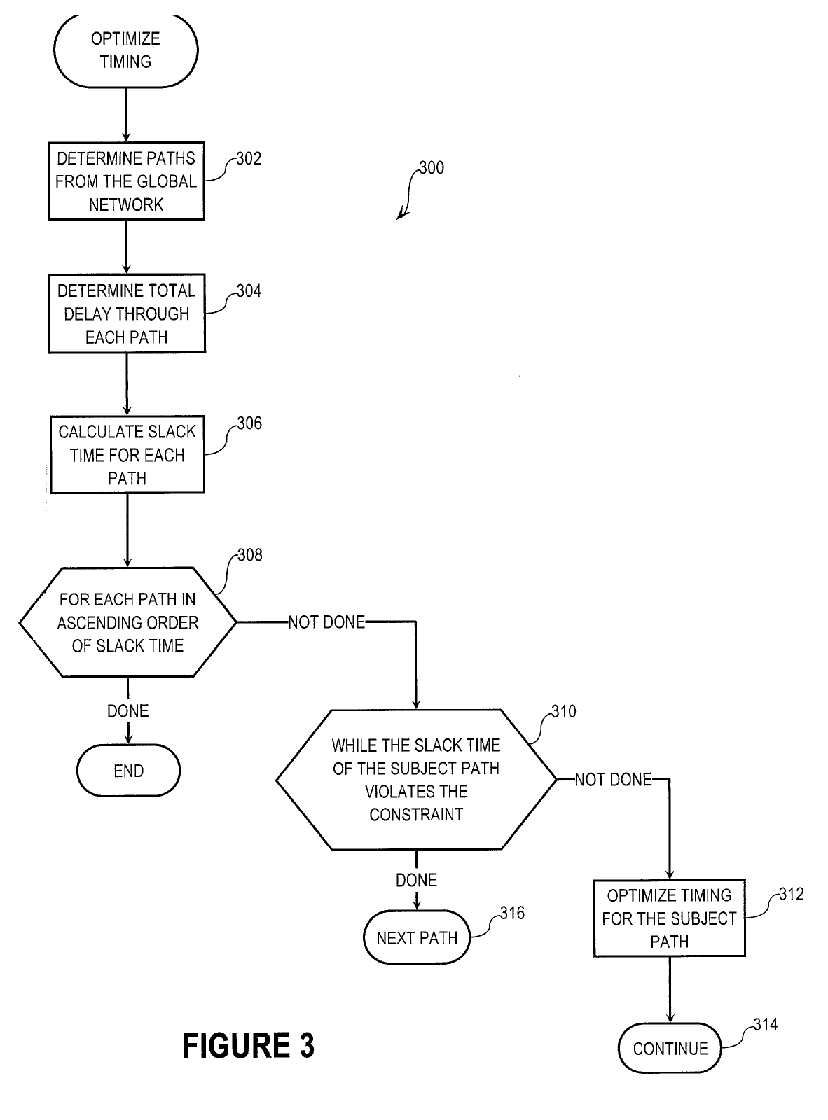

Upon initiation by the user, CAD application 1210 optimizes timing of the global network shown in FIG. 1 in the manner illustrated by logic flow diagram 300 (FIG. 3). In step 302, CAD application 1210 (FIG. 12) determines the various paths of the entire global network as represented in design specification database 1212. As described above, the global network of FIG. 1 includes two paths: one from I/O pad 112 to I/O pad 114 and another from I/O pad 112 to I/O pad 116.

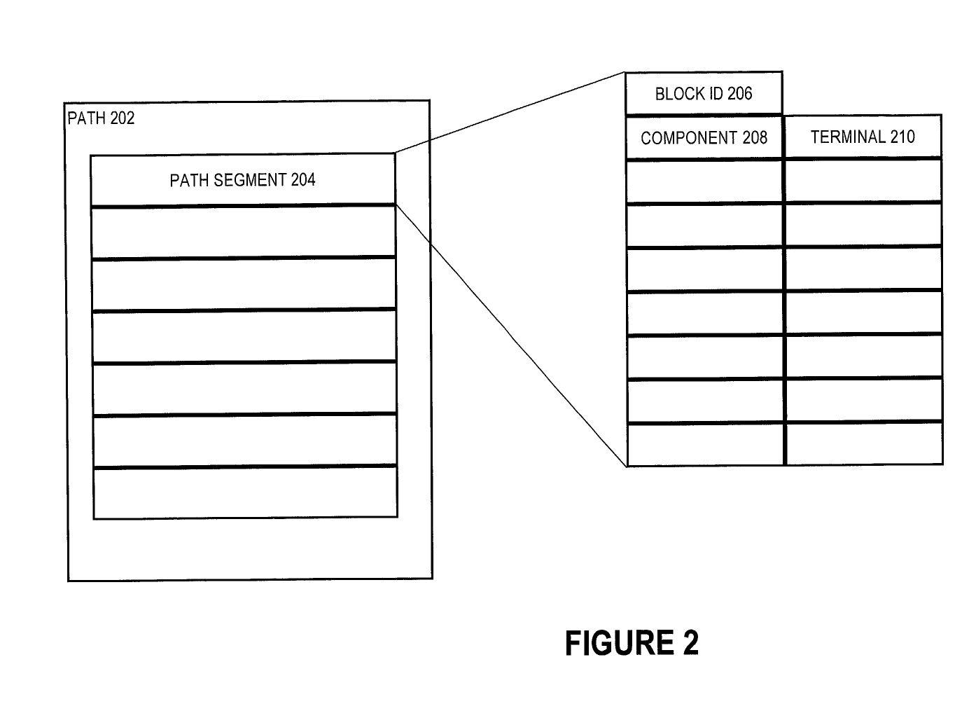

In step 304, CAD application 1210 (FIG. 12) divides the path of the global network at soft block boundaries. In particular, each path is divided at pins 170-182 (FIG. 1). CAD application 1210 (FIG. 12) stores data representing the path segments of a particular path in design specification database 1212 using a path structure such as path structure 202 (FIG. 2).

Path structure 202 includes a series of path segment structures 204. Each path segment structure 204 includes a block identifier 206, a component identifier 208, and a terminal identifier 210. Component identifier 208 identifies a particular element of design 100 (FIG. 1), and terminal identifier 210 (FIG. 2) identifies a specific terminal of the identified component. Block identifier 206 identifies the logical block to which the path segment belongs. Block identifier 206 can identify a soft block or the top level. Block identifier 206 is important because recording to which logical block elements of the path pertain allows the global network to be subsequently divided at soft block boundaries after timing is optimized on design 100 as a whole.

In this illustrative example, the first path is divided into path segments as follows: (i) a path segment at the top level from I/O pad 112 to soft pin 170; (ii) a path segment of soft block 102 from soft pin 170 to an input terminal of element 120 to an output terminal of element 120 to an input terminal of element 124 to an output terminal of element 124 to soft pin 172; (iii) a path segment of the top level from soft pin 172 to soft pin 174; (iv) a path segment of soft block 104 from soft pin 174 to an input terminal of element 128 to an output terminal of element 128 to soft pin 178; and (v) a path segment of the top level from soft pin 178 to I/O pad 114.

In step 306 (FIG. 3), CAD application 1210 (FIG. 12) determines the slack time of each path of the global network. Specifically, CAD application 1210 determines the total delay through each path and compares that total delay to a predetermined delay constraint specified as part of the design specification. It should be noted that, while conventional hierarchical delay evaluation mechanisms only determine delay through individual soft blocks and disregard the remainder of a design, step 306 (FIG. 3) involves determining delay through an entire path and considering an entire global network.

Loop step 308 and next step 316 define a loop in which CAD application 1210 (FIG. 12) processes each path of the global network individually according to steps 310-314 (FIG. 3). During each iteration of the loop of steps 308-316, the particular path processed according to steps 310-314 is sometimes referred to as the subject path. Once each path of the global network has been processed according to the loop of steps 308-316, processing according to logic flow diagram 300 completes. For each path of the global network, processing transfers to loop step 310.

In the loop of steps 308-316, CAD application 1210 (FIG. 12) processed the paths of the global network in ascending order of slack times. To do so, CAD application 1210 sorts the paths of the global network according to the slack times determined in 306. If a particular path fails to meet its constraint, the slack time for that path is negative. The smallest slack time, i.e., the negative slack time with the largest magnitude, represents the path whose timing is the worst relative to the specified timing constraint for the path and, therefore, the path which probably requires the most significant modification to satisfy the constraint of the path. As is described more completely below, solving the timing problems of the worst paths first can also resolve timing problems in less problematic paths without specifically addressing those less problematic paths.

In loop step 310, CAD application 1210 (FIG. 12) determines whether a timing constraint of the subject path of the global network is satisfied. Any such timing constraint is specified in design specification database 1212 and specifies a maximum amount of time a signal can require to propagate through the subject path. If the timing constraint is satisfied by the subject, processing transfers to next step 316 and the next path is processed according to the loop of steps 308-316. Conversely, if the timing constraint of the subject path is not satisfied, processing transfers to step 312.

In step 312 (FIG. 3), CAD application 1210 (FIG. 12) optimizes the timing of the subject path in a manner described in more detail below. After step 312 (FIG. 3), processing transfers through next step 314 to loop step 310 in which CAD application 1210 (FIG. 12) again determines whether the subject path, as modified in step 312 (FIG. 3), satisfies the timing constraint of the subject path. Thus, loop step 310 involves calculating the slack time of the subject path again. In the first performance of loop step 310 for the first path of the global network, the slack time calculation of step 306 can be used. However, subsequent performances of loop step 310 should calculate the slack time of the subject path anew. For the first path of the global network, performance of step 312 changes the path as described below and therefore changes the slack time of the subject path. Any changes to the first path of the global network can affect slack times for other paths of the global network and so loop step 310 involves independent calculation of slack times for paths of the global network.

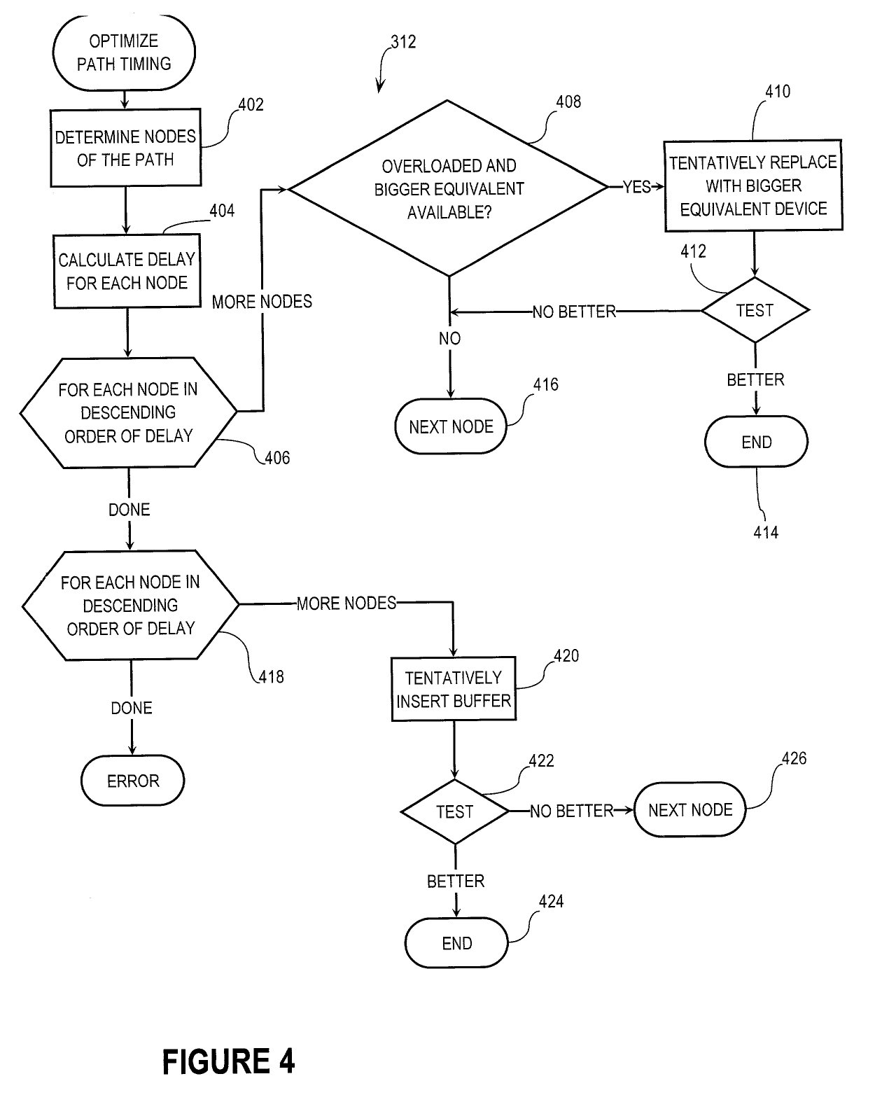

Thus, according to logic flow diagram 300, CAD application 1210 (FIG. 12) processes the respective paths of the global network in order of ascending slack times, repeatedly optimizing each path according to step 312 until the path satisfies its constraint. Step 312 is shown in greater detail as logic flow diagram 312 (FIG. 4).

In step 402, CAD application 1210 (FIG. 12) divides the subject path into nodes. Herein, nodes are defined as a portion of the path from input of a particular device to an input of a device driven by the particular device. Soft pins are considered devices in this illustrative embodiment. The following example is illustrative. Consider that the subject path is the first path described above. Starting with I/O pad 112, the first node is line 140, ending at soft pin 170. The second node is line 142, starting at soft pin 170 and ending at the input of device 120. The third node starts with the input of device 120, and therefore includes device 120, and includes line 144, ending at an input to device 124. The next node starts with the input of device 124, and therefore includes device 124, and includes line 146, ending at soft pin 172. The remaining nodes are determined in a similar manner.

In step 404 (FIG. 4), CAD application 1210 (FIG. 12) calculates the delay of each node. Such calculation includes consideration of the devices driven by a particular device. For example, to calculate the delay through the node which includes device 120 (FIG. 1), CAD application 1210 (FIG. 12) determines the time required for device 120 (FIG. 1) to drive input signals of devices 122 and 124. Stated another way, the delay of the node including device 120 includes a device delay, i.e., the delay through device 120, which is heavily influenced by the outgoing load of device 120 and an interconnect delay, i.e., the delay of a signal propagating through line 144 to device 124.

Outgoing load estimation by CAD application 1210 (FIG. 12) involves looking beyond soft pins in some instances. For example, the node involving device 124 ends at soft pin 146 while the outgoing load of device 124 considers input capacitance of devices 126 and 128 and the total effective capacitance of wires that connects from the outgoing terminal of device 124 to input terminal of devices 126 and 128.

Loop step 406 and next step 416 define a loop in which CAD application 1210 (FIG. 12) processes each node of the subject path in descending order of delay. Accordingly, CAD application 1210 (FIG. 12) sorts the nodes of the subject path according to descending order of delay to first process the node for which the delay is greatest and to attribute the lowest priority to the node for which the delay is least. In each iteration of the loop of steps 406-416, the node processed by CAD application 1210 (FIG. 12) is referred to as the subject node.

In test step 408 (FIG. 4), CAD application 1210 (FIG. 12) determines whether the device of the subject node is overloaded and whether a bigger equivalent device is available. In the context of steps 408-410, “bigger” refers to a greater number of devices, or equivalently greater capacitance, which can be driven by a particular device. A bigger equivalent device is one that performs the same function but can drive more devices. For example, a logical AND gate which is designed to drive eight (8) inputs is a bigger equivalent to a logical AND gate which is designed to drive four (4) inputs. Determination of the number of devices a particular device is designed to drive is described more completely below. A particular device is overloaded if the device drives more devices than the number for which the particular device is designed. Continuing in this illustrative example, a logical AND gate which is designed to drive four (4) devices can drive six (6) devices as specified in design specification database 1212 (FIG. 12). Such would add delay since it would take time for a 4-device output signal of the logical AND gate to drive six (6) devices.

One implementation issue is how to process a device for which several bigger, equivalent devices are available. Continuing in the above example, consider that the device of the subject node is a logical AND gate and is designed to drive four (4) devices. Consider further that the device of the subject node in fact drives eight (8) devices and that equivalent logical AND gates are available: one that is designed to drive six (6) devices and one that is designed to drive eight (8) devices. In one embodiment, the device of the subject node is replaced with the former equivalent device hoping that the delay will improve sufficiently to satisfy the constraint. This new device, e.g., the logical AND gate which drives six (6) devices, can be later replaced with the latter equivalent device in a subsequent iteration of the loop of steps 310-314 (FIG. 3) if the former equivalent device fails to improve the delay sufficiently to satisfy the constraint. In an alternative embodiment, the original device of the subject node is immediately replaced with the latter equivalent device, e.g., the logical AND gate designed to drive eight (8) devices, to facilitate satisfying the constraint more quickly but perhaps sacrificing area since the latter equivalent device is likely physically larger than the former equivalent device.

It should be appreciated that, in test step 408, CAD application 1210 (FIG. 12) first process the longest delay node, as selected in loop step 406, of the subject path. In addition, as described above with respect to FIG. 3, the worst path of the global network is processed first. Thus, the worst node of the worst path is processed first.

If, in test step 408 (FIG. 4), the device of the subject node is not overloaded or has no equivalent, bigger device, processing transfers through next step 416 to loop step 406 in which the node with the next largest delay is processed according to the loop of steps 406-416.

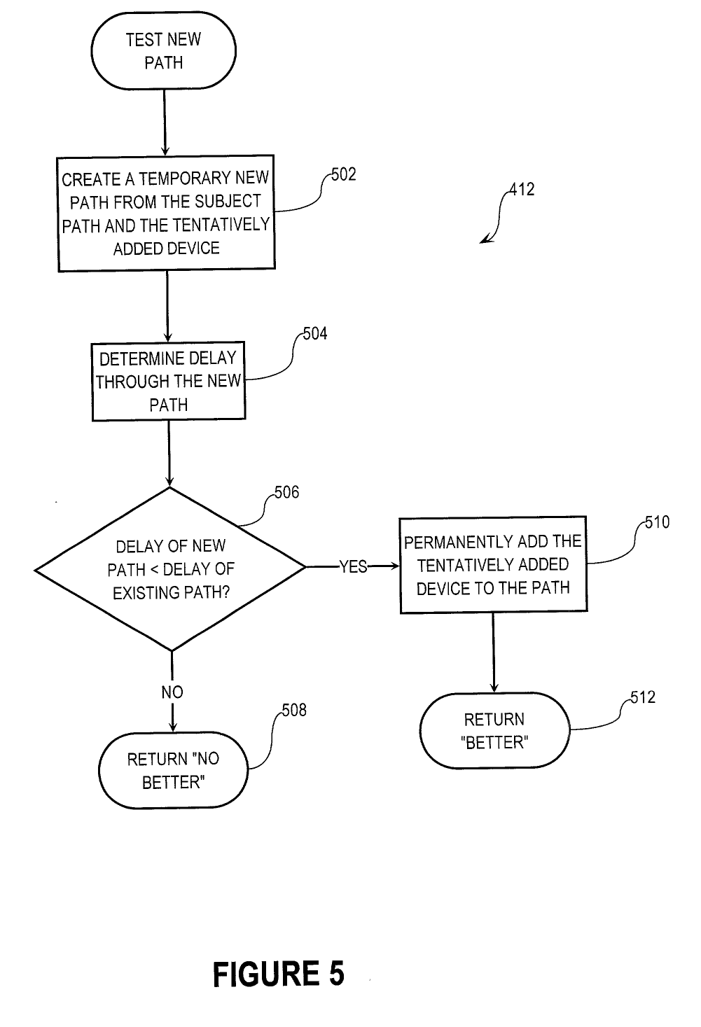

Conversely, if the device of the subject node is overloaded and a bigger equivalent device is available, processing transfers to step 410 in which the bigger equivalent device is tentatively substituted for the device of the subject node. After step 410, processing by CAD application 1210 (FIG. 12) transfers to test step 412 (FIG. 4) in which CAD application 1210 determines whether the substitution improves the timing of the subject path. Test step 412 is shown in greater detail as logic flow diagram 412 (FIG. 5).

In step 502, CAD application 1210 (FIG. 12) creates a temporary, new path from the subject path and the tentatively included device, replacing the equivalent, smaller device in the context of step 412 (FIG. 4). In step 504 (FIG. 5), CAD application 1210 (FIG. 12) determines the delay through the temporary, new path in a manner analogous to the determination of the delay through the subject path originally.

In test step 506 (FIG. 5), CAD application 1210 (FIG. 12) determines whether the delay through the temporary, new path is less than the delay through the path prior to the most recent tentative change. The delay through the path prior to the most recent tentative change is the delay determined in a prior, most recent performance of step 504 for the same path, or determined in step 306 (FIG. 3), whichever is least. If the delay of the temporary, new path is not less than the delay of the subject path without the tentative change, processing transfers to terminal step 508 (FIG. 5) in which a result of “no better” is returned and the tentative change is ignored; the subject path remains unchanged. In test step 412 (FIG. 4), a result of “no better” transfers processing through next step 416 to loop step 406 in which the node of the subject path with the next longest delay is processed according to steps 408-414.

Conversely, if the delay of the temporary, new path is less than the delay of the path prior to the tentative change, processing transfers from test step 506 to step 510. In step 510, CAD application 1210 (FIG. 12) makes the tentative change permanently within design specification 1212. Specifically, the device of the subject node is replaced with the bigger, equivalent device within design specification database 1212.

Replacement of the device of the subject node within design specification database 1212 can affect other paths. In this illustrative example, device 120 (FIG. 1) is common to both paths. Accordingly, replacement of device 120 with a bigger, equivalent device to improve the timing of one path improves timing through all paths which include device 120. Since CAD application 1210 (FIG. 12) processes the paths with the worst timing problems first, it is possible and even likely that resolving timing issues with the worst paths can resolve timing issues with less problematic paths if those paths share devices. As a result, optimizing global network timing in the manner described herein provides particularly efficient resolution of timing problems.

Perhaps the most important feature of the described timing optimization is that, while the paths of the global network are processed globally, information as to which logical block each element belongs is maintained. For example, when device 120 (FIG. 1) is replaced with a bigger, equivalent device, CAD application 1210 (FIG. 12) replaces device 120 (FIG. 1) within the appropriate path segment structure, e.g., in all component identifiers 208 (FIG. 2), such that block identifier 206 identifies the logical block to which any substitute or newly added devices belong. Such enables reversion from the global perspective for timing optimization to the soft block level for additional processing and evaluation. Accordingly, solving timing issues on a global level does not require all subsequent processing to be performed according to a flat paradigm. Instead, all improvements made to the overall circuit design are associated with a logical block of the circuit design and the portion of the design pertaining to a particular logical block, e.g., soft block 102 (FIG. 1), includes those changes made to elements of that logical block during timing optimization.

After step 510 (FIG. 5), processing transfers to terminal step 512 in which CAD application 1210 (FIG. 12) returns a value of “better” to indicate that the tentative change improved timing through the subject path and that the tentative change was therefore permanently adopted. When test step 412 (FIG. 4) returns a result of “better,” processing according to logic flow diagram 312, and therefore step 312 (FIG. 3), completes. In particular, after one permanent change is made to the subject path, CAD application 1210 (FIG. 12) re-evaluates the subject path in loop step 310 to determine whether the subject path satisfies the constraint of the subject path. In short, the subject path is improved only as much as is required to satisfy the constraint of the subject path. Excessively improving timing of the subject path can result in excessively large and/or numerous devices in the subject path and thus an excessively large circuit. In many circuit designs, physically smaller circuits are preferred.

Returning to the loop of steps 406-416 (FIG. 4), it is possible that none of the nodes of the subject path include overloaded devices for which bigger equivalent devices are available. In such a case, processing of all nodes of the subject path according to the loop of steps 406-416 transfers processing to loop step 418. Loop step 418 and next step 426 define a loop in which CAD application 1210 (FIG. 12) processes each node of the subject path in descending order of delay, i.e., in the same order processed in the loop of steps 406-416 (FIG. 4). In each iteration of the loop of steps 418-426, the node processed by CAD application 1210 (FIG. 12) is referred to as the subject node.

In step 420, CAD application 1210 (FIG. 12) tentatively inserts a buffer after the device of the subject node. Continuing in the illustrative example above, suppose that the device is a logical AND gate designed to drive four (4) devices but drives six (6) devices and no bigger logical AND gate is available. In step 420 (FIG. 4), CAD application 1210 (FIG. 12) inserts a buffer with sufficient size to drive six (6) devices and attaches the buffer to the output of the subject device. Accordingly, the logical AND gate drives the buffer very quickly and the buffer drives the six (6) driven devices relatively quickly as well.

Since the path is divided at soft pins at soft block boundaries in the manner described above, inserting a buffer into a node inserts the buffer within the soft block to which the device of the subject node belongs. The following example is illustrative. Consider that the node of device 124 and line 146 has the longest delay of all nodes of the path from I/O pad 112 to I/O pad 114 and that no node of that path has an overloaded device for which a bigger, equivalent device is available. Accordingly, processing by CAD application 1210 (FIG. 12) according to logic flow diagram 312 (FIG. 4) tentatively inserts a buffer at the output of device 124 (FIG. 1). Since the node which includes device 124 is wholly contained within soft block 102 as represented within the path segment structure shown in FIG. 2, the tentatively added buffer will also be added within soft block 102 (FIG. 1). Thus, when timing optimization is complete and additional work on the subject circuit design is to be performed on individual logical blocks, the tentatively added buffer will be included with soft block 102. Without tracking into which logical blocks new devices are added, reversion to a block level for subsequent processing is particularly difficult.

After step 420 (FIG. 4), CAD application 1210 (FIG. 12) tests the tentatively added buffer in test step 422 (FIG. 4). Test step 422 (FIG. 4) is analogous to test step 412 described above with respect to logic flow diagram 412 (FIG. 5), except that the tentative change is an inserted buffer rather than a device substitution. If the tentatively inserted buffer improves the timing of the subject path, processing according to logic flow diagram 312 (FIG. 4), and therefore step 312 (FIG. 3), completes and CAD application 1210 (FIG. 12) re-evaluates the timing of the subject path to determine whether the constraint of the subject path is satisfied in the manner described above. Conversely, if the tentatively inserted buffer does not improve timing of the subject path, the buffer is disregarded and the next node of the subject path is considered by CAD application 1210 (FIG. 12) in a subsequent iteration of the loop of steps 418-426 (FIG. 4).

Processing by CAD application 1210 (FIG. 12) reaches error step 430 only if no node of the subject path includes a device which is overloaded and has a bigger, equivalent device and no node of the subject path can be improved by inserting a buffer into the node. Under such circumstances, the subject path as it is currently specified cannot be made to meet the constraint for that path.

Thus, CAD application 1210 (FIG. 12) processes each path of the global network in order of ascending slack time and repeated makes incremental improvements in each path until each path satisfies its corresponding constraint. In making such incremental changes, CAD application 710 associates with each newly added device, whether by insertion or substitution, data representing a logical block to which the newly added device belongs. As a result, timing issues can be resolved at a global level and any changes made to the design in resolving those timing issues are carried back to the block level at which great improvement in efficiency is realized over processing according to flat paradigms.

As described above, the first path includes a node which includes device 124 and line 146. It would appear, looking only at this node—e.g., while processing the nodes of soft block 102 only, that device 124 drives only a short length of wire. However, reference to FIG. 1 shows that device 124 drives more than that. Accordingly, it is necessary for CAD application 1210 (FIG. 12) to look beyond the boundary of soft block 102 to determine the loading of device 124. Accordingly, determining delay through the node of device 124 and line 146 requires outgoing load estimation.

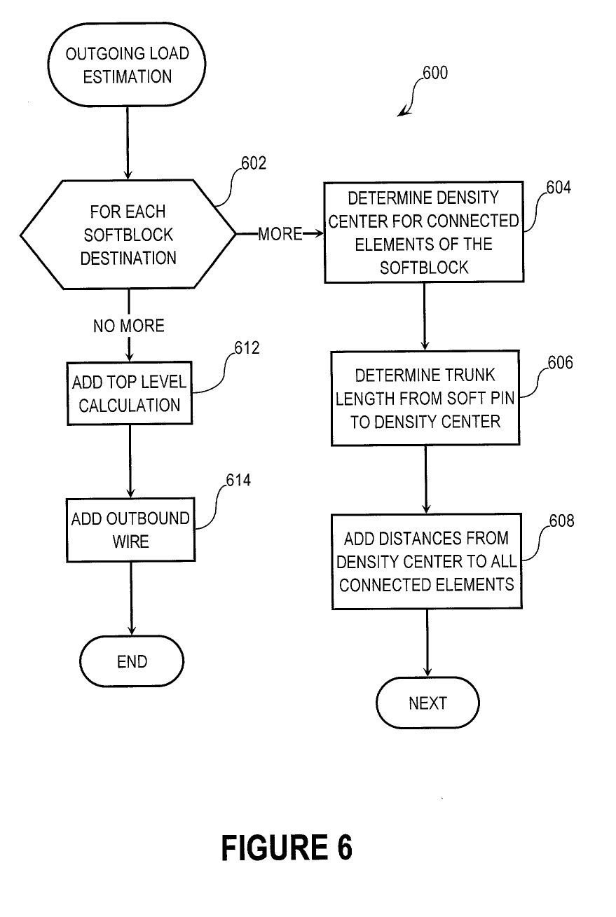

One of the advantages of circuit design according to the hybrid paradigm is that individual soft blocks can be routed independently of one another. It would be advantageous if global timing solutions can be achieved even if one or more of the soft blocks of a circuit design according to the hybrid paradigm remain un-routed. For illustration purposes, consider that soft block 104 is not currently routed—e.g., that the precise routing of line 152 is not yet known. CAD application 1210 (FIG. 12) estimates outgoing load of a node when the subject path is not routed in the soft block of the driven devices in the manner shown in logic flow diagram 600 (FIG. 6).

Loop step 602 and next step 610 define a loop in which each soft block destination of the outgoing signal is processed according to steps 604-608. In this illustrative example, the outgoing signal, i.e., the signal at soft pin 172 (FIG. 1), travels to soft block 104 only. During an iteration of the loop of steps 602-610, the soft block processed according to steps 604-608 is referred to herein as the subject soft block.

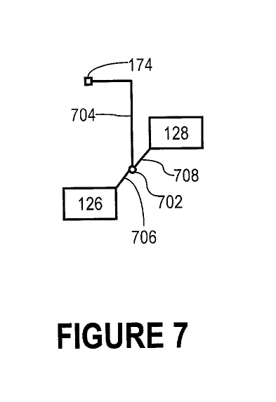

In step 604 (FIG. 6), CAD application 1210 (FIG. 12) determines the density center for all elements of the subject soft block which are connected to the outgoing signal for which load is being estimated, e.g., devices 126 and 128 which are connected to soft pin 174 in this illustrative example. CAD application 1210 calculates the density center in a manner described in U.S. patent application Ser. No. 09/305,802 by Cai, Zhen entitled “Placement-Based Pin Optimization Method and Apparatus for Computer-Aided Circuit Design” filed May 4, 1999 (hereinafter the '802 Application) and that description is incorporated herein by reference. FIG. 7 is illustrative and shows a density center 702 of devices 126 and 128.

In step 606 (FIG. 6), CAD application 1210 (FIG. 12) determines a length of a trunk 704 (FIG. 7) from the soft pin of the subject soft block, e.g., soft pin 174 of soft block 104, to density center 702. In step 608 (FIG. 6), CAD application 1210 (FIG. 12) adds distances 706 (FIG. 7) and 708 from density center 702 to all connected devices, e.g., devices 126 and 128. Thus, the length of trunk 704 plus distances 706-708 provides a reasonable estimate of the length of an ultimately routed network within the subject soft block to devices 126 and 128 without requiring that the network be routed within the subject soft block.

If multiple soft blocks are processed according to the loop of steps 602-610, the estimated routing of the soft blocks is accumulated. In step 612, CAD application 1210 (FIG. 12) adds to the cumulative estimated routing the length of the top level routing of the subject network, e.g., line 150 of the top level. In step 614 (FIG. 6), CAD application 1210 (FIG. 12) adds to the cumulative estimated routing the length of the outbound wire, e.g., wire 146 in this illustrative example. Thus, the estimated load of device 122 includes wires 146 and 150 and estimated trunk 704 and distances 706-708. Thus, even when considering the path segment of soft block 102 in isolation, the full loading of device 124 is properly analyzed, ensuring a proper result when optimizing timing in the manner described above with respect to logic flow diagram 300 (FIG. 3).

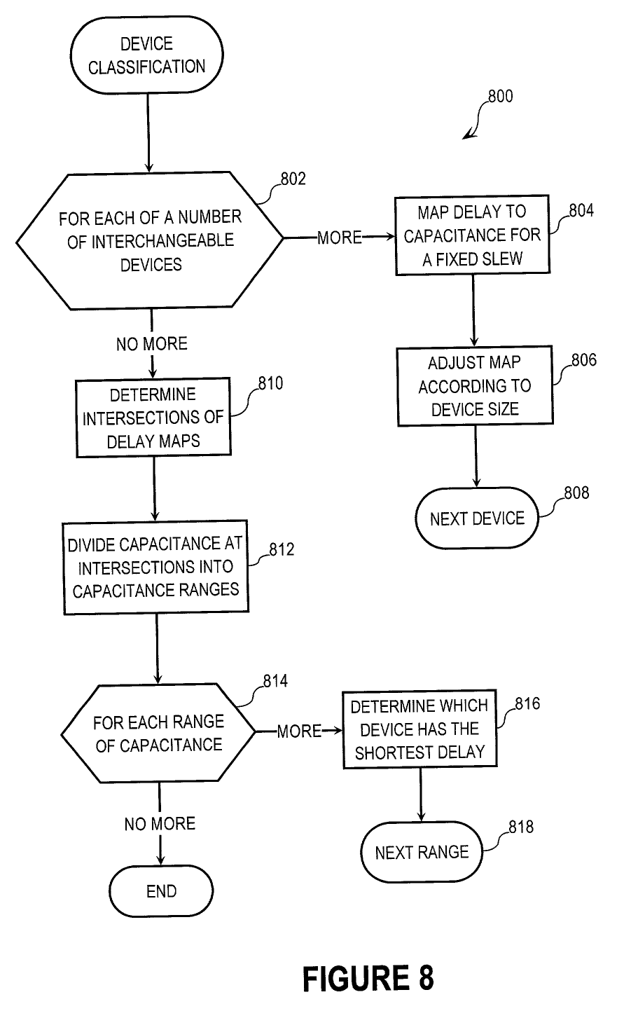

As described above, devices of a particular logical function are categorized according to driving ability. Logic flow diagram 800 (FIG. 8) illustrates the manner in which CAD application 1210 (FIG. 12) categorizes interchangeable devices. It should be noted that such categorization can be performed once, the results stored in design specification database 1212 or elsewhere within memory 1204 and reused for timing optimization of numerous circuit designs.

Loop step 802 and next step 808 define a loop in which CAD application 1210 (FIG. 12) processes a number of interchangeable devices according to steps 804 (FIG. 8) and 806. Devices are interchangeable if they perform equivalent functions. For example, logical AND gates of various sizes can be considered interchangeable devices. During each iteration of the loop of steps 802-808, the particular device processed according to steps 804-806 is sometimes referred to herein as the subject device.

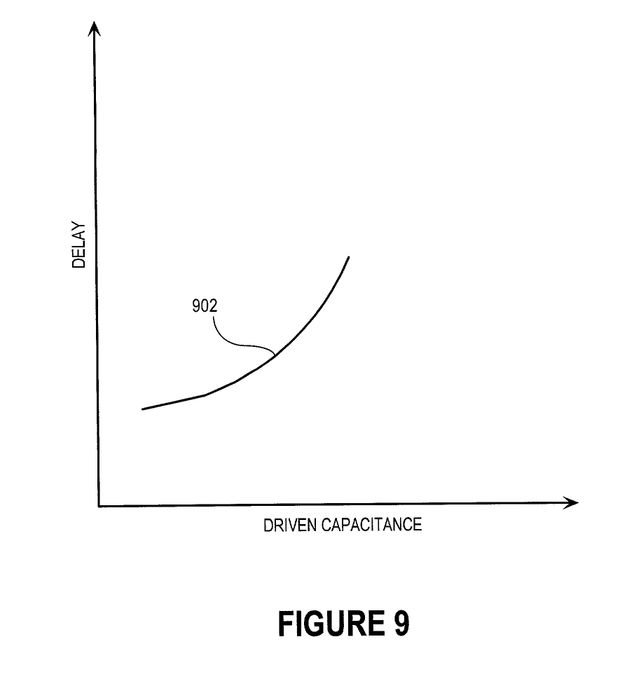

In step 804, CAD application 1210 (FIG. 12) maps delay to capacitance for a fixed slew for the subject device. Most device specifications provide a non-linear delay model which specifies delay for given slews and driven capacitances. To map delay to capacitance, CAD application 1210 (FIG. 12) selects a fixed slew and retrieves delays for various driven capacitances. CAD application 1210 then interpolates delays between those specified in the non-linear delay model of the subject device. The result of such interpolation can be represented as a graph 902 of delay as a function of driven capacitance as shown in FIG. 9.

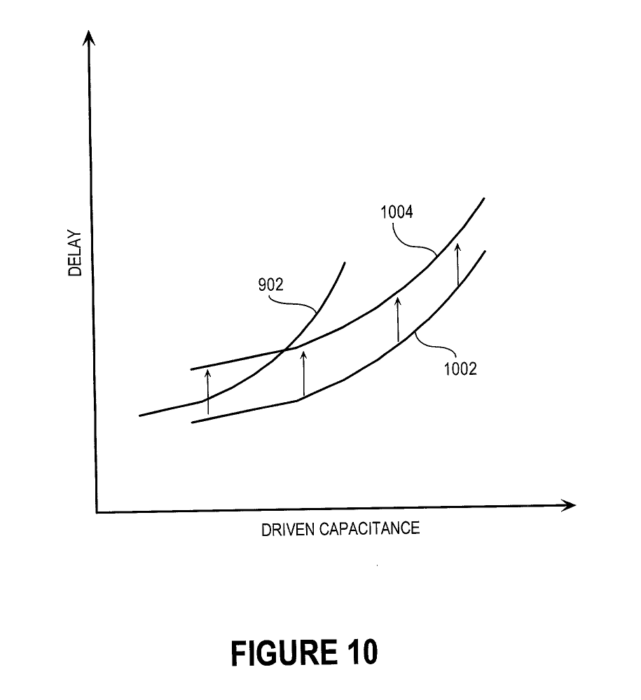

In step 806, CAD application 1210 (FIG. 12) adjusts the delay/capacitance mapping according to the size of the subject device. FIG. 10 is illustrative. Graph 902 represents a delay function of a particular device. Graph 1002 represents an unadjusted delay function of an equivalent device, i.e., a device which is equivalent with the device whose delay function is represented by graph 902. Graphs 902 and 1002 show that the second device always produces a shorter delay regardless of the driven capacitance. However, in this illustrative example, the device of graph 1002 is physically larger than the device of graph 902. Accordingly, the device of graph 902 is generally preferred so long as the delay is not excessive. CAD application 1210 (FIG. 12) therefore adjusts the delay/capacitance mapping of the second device according to the physical size of the second device to produce graph 1004. Comparison of graph 902 to graph 1004 shows that, for some driven capacitances, the device of graph 902 produces less delay. More accurately, for some driven capacitances, the device of graph 902 represents a better trade-off of delay for smaller physical size.

$$AreaFactor = [ \frac{A ( {D}_{L} ) - A ( {D}_{S} )}{A ( {D}_{S} )} \times {W}_{A} ] + 1 \qquad [ m1 ]$$

The equation above specifies an area factor by which CAD application 121 0 (FIG. 12) scales the delay/capacitance of graph 1002 (FIG. 10) to produce the delay/capacitance mapping of graph 1004. In the above equation, A(D_{S}) represents the physical area of the smaller device, e.g., the device of graph 902. A(D_{L}) represents the physical area of the larger device, e.g., the device of graph 1002. W_{A} represents an area factor weight and specifies a weight to attribute to the percentage difference between the smaller device and the larger device. The area factor weight is 0.5 in this illustrative embodiment.

After step 806 (FIG. 8), processing by CAD application 1210 (FIG. 12) transfers through next step 808 to loop step 802 in which the next interchangeable device is processed according to the loop of steps 802-808. If all interchangeable devices have been processed in steps 802-808, processing transfers to step 810. In step 810, CAD application 1210 (FIG. 12) determines intersections of delay/capacitance mappings.

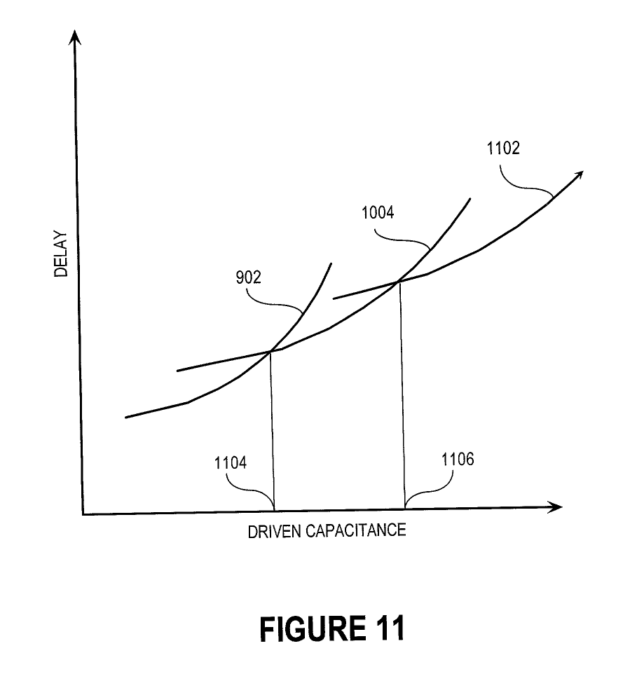

For example, FIG. 11 shows graphs 902, 1004, and 1102 for three (3) interchangeable devices after the loop of steps 802-808. Graphs 902 and 1004 intersect at a driven capacitance 1104, and graphs 1004 and 1102 intersect at a driven capacitance 1106.

In step 812 (FIG. 8), CAD application 1210 (FIG. 12) determines capacitance ranges divided by the intersection driven capacitances 1104-1106 (FIG. 11). Loop step 814 and next step 818 define a loop in which CAD application 1210 (FIG. 12) processes each capacitance according to step 816 (FIG. 8). In step 816, CAD application 1210 (FIG. 12) determines which device has the shortest delay within the subject capacitance range. In particular, CAD application 1210 determines, in performing steps 812-818, that (i) the device of graph 902 (FIG. 11) is to be used for driven capacitances below driven capacitance 1104; (ii) the device of graph 1004 is to be used for driven capacitances of at least driven capacitance 1104 and below driven capacitance 1106; and (iii) the device of graph 1102 is to be used for driven capacitances of driven capacitance 1106 or greater.

The above description is illustrative only and is not limiting. The present invention is limited only by the claims which follow.

What is claimed is:

1(c1)] A method for improving timing in a signal path of a circuit design (i) which includes two or more logical blocks and (ii) in which the signal path includes two or more signal path segments which are each in a respective one of the logical blocks of the circuit design, the method comprising:
making one or more changes to the signal path to improve the timing of the signal path; and
for each of the one or more changes:
(i) determining that the change is associated with a selected one of the signal path segments; and
(ii) associating the change with data representing the logical block within which the selected signal path segment is.

2(c2)] The method of claim 1 wherein making comprises:
replacing an element of the signal path with a faster equivalent element.

3(c3)] The method of claim 1 wherein making comprises:
inserting a buffer between a selected element of the signal path and driven elements of the selected element.

4(c4)] A method for estimating an outgoing load of an element of a signal path of a circuit design, the method comprising:
determining that the element drives input signals for one or more driven elements;
determining the density center of the driven elements; determining a distance between the density center and the element as a driven line load estimate;
determining distances from the density center to each of the driven elements; and
adding the distances to the driven line load estimate.

5(c5)] The method of claim 4 wherein determining a distance between a density center and the element comprises:
determining a distance from a first soft pin at a first border of a first soft block which includes the driven elements to the density center;
a top level distance from a second soft pin at a second border of a second soft block which includes the element to the first soft pin;
determining an outgoing line distance from an output terminal of the element to the second soft pin; and
summing the distance, the top level distance, and the outgoing line distance to estimate the distance between the density center and the element.

6(c6)] A method for categorizing circuit elements for delay analysis, the method comprising:
for various driven capacitances, determining which of a number of functionally equivalent elements provides a shortest signal delay; and
categorizing the functionally equivalent elements according to the driven capacitances for which each provides the shortest signal delay.

7(c7)] The method of claim 6 wherein determining comprises:
for the various driven capacitances, mapping the driven capacitances to signal delays for each device.

8(c8)] The method of claim 7 wherein determining further comprises:
adjusting the driven capacitances of each element according to a physical size of each element.
